(19) United States
(12) Patent Application Publication
(10) Pub. No.: US 2007/0028857 A1
(43) Pub. Date: Feb. 8, 2007

(54) Wound cover

(76) Inventor: Kathleen A. Cooney, Kentwood, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/486,694

(22) Filed: Jul. 14, 2006

Related U.S. Application Data
(60) Provisional application No. 60/706,340, filed on Aug. 8, 2005.

(51) Int. Cl. A01K 13/00

(52) U.S. Cl. 119/850

(57) ABSTRACT

A wound cover includes a plastic tubular body, which has a length sufficient to cover a wound on an appendage and has an upper open end for extending around the appendage, and a strap for extending around the appendage. The strap is coupled to the tubular body for securing the tubular body to the appendage over the wound. In addition, the tubular body is vented to allow heat and moisture to escape and to facilitate air circulation around the wound.

This application claims the benefit of provisional patent application entitled WOUND COVER, filed Aug. 8, 2005, Ser. No. 60/706,340, which is incorporated herein by reference in its entirety.

### TECHNICAL FIELD AND BACKGROUND OF THE INVENTION

The present invention relates to a wound cover for animals, and more particularly, to a wound cover for protecting a wound on an appendage of the animal.

When an animal has a wounded appendage, the appendage is typically bandaged with a cloth material that is wrapped around the appendage and over the wound. However, bandages tend to loosen and soil, and further, when wet, may cause moist dermatitis. In addition, in the case of most bandages, the bandage blocks the visualization of the wound.

In order to prevent the animal from gnawing or chewing on the bandage to remove the bandage, animals are often fitted with a neck collar. The collars, however, can create problems. For example, they may cause the animal to get trapped or caught up on something, such as furniture, railing, or the like.

More recently, paw protectors have been designed to protect the bandage and, hence, prolong the useful life of the bandage; thus eliminating the need for neck collars. However, like bandages, these protectors prevent visualization of the wound. Furthermore, while these protectors are stronger and more durable than conventional bandages, their stiffness tends to inhibit the animal's use of its wounded appendage. Further, they tend to trap heat and moisture around the wound and limited air circulation to the wound. In some applications, the rigidity of the protector necessitates the strap that secures the protector to be located below the carpus or tarsus, which increases the risk of the animal removing the protector or the protector simply falling off. Other types of protectors have the disadvantage of being too thin and require multiple straps to secure the protector to the appendage and, thus often limit the range of motion of the appendage.

### SUMMARY OF THE INVENTION

The present invention provides a wound cover that provides a better fit, and further allows for visibility of the wound. Furthermore, the cover is adapted to allow moisture and heat to escape and provide improved circulation to reduce, if not eliminate, the common cause of moist dermatitis.

In one form of the invention, a wound cover includes a plastic tubular body having a length sufficient to cover a wound on an appendage and a strap for extending around the appendage, which is coupled to the tubular body for securing the tubular body to the appendage over the wound. The tubular body is vented to allow heat and moisture to escape, and to facilitate air circulation around the wound.

In one aspect, the tubular body includes a plurality of openings to form vents.

In another aspect, the cover further includes a foraminous sleeve that extends from the upper open end of the tubular body and couples to the tubular body. The foraminous sleeve includes a plurality of openings to vent the tubular body. The strap is coupled to the sleeve for securing the sleeve and the tubular body to the appendage over the wound. For example, the sleeve may be formed from a flexible plastic.

In yet another aspect, the tubular body has a first wall thickness, and the sleeve has a second wall thickness that is thinner than said first wall thickness. In this manner, the sleeve is more flexible than the tubular body, which provides a better fit for the cover.

In a further aspect, the plastic tubular body comprises a substantially transparent plastic tubular body so that the wound will be visible through the cover which allows for better monitoring of the wound. In addition, the tubular body may incorporate a flavor additive, which deters an animal wearing the wound cover from chewing on the cover.

In accordance with another form of the invention, a wound cover includes a transparent plastic tubular body, with a length sufficient to cover a wound on an appendage, and a strap for extending around the appendage, which is coupled to the tubular body for securing the tubular body to the appendage over the wound. The tubular body is semi-rigid to retain its general shape and has an upper open end that extends around the appendage and allows the appendage to be inserted into the cover.

In one aspect, the cover also includes a foraminous sleeve that extends from the upper open end and couples to the tubular body. The foramanious sleeve includes a plurality of openings to allow heat and moisture to escape and to facilitate air circulation around the wound. The strap is coupled to the sleeve for securing the sleeve and the tubular body to the appendage over the wound.

In another aspect, the tubular body includes a closed end opposed from the upper open end to form a paw enclosure.

According to yet another form of the invention, a wound cover includes a plastic tubular body that is semi-rigid to retain its general shape. The tubular body has an upper open end for extending around the appendage and to allow the appendage to be inserted into the cover. In addition, the cover includes a plastic sleeve for extending around the appendage, which has a thickness less than the thickness of the tubular body wherein the sleeve is more flexible than the body to allow the cover to more easily conform to the appendage. The sleeve is vented to allow heat and moisture to escape and to facilitate air circulation around the wound. In addition, the cover includes a strap that extends around the appendage and is coupled to the tubular body for securing said tubular body to the appendage over the wound

In one aspect, the sleeve comprises a foraminous sleeve, which includes a plurality of openings to vent the tubular body.

In yet another form of the invention, a wound cover includes a plastic tubular body having a length sufficient to cover a wound on an appendage, a strap coupled to the tubular body for extending around the appendage for securing the body to the appendage over the wound, and a flavor additive incorporated into the tubular body. The flavor additive is provided to deter an animal wearing the wound cover from chewing on the tubular body.

In one aspect, the tubular body is vented to allow heat and moisture to escape and to facilitate air circulation around the wound.

Accordingly, the present invention provides a wound cover that will provide a protective cover that allows for better monitoring of a wound, and which will provide a better fit than most conventional protectors. In addition, the cover allows venting of heat and moisture and, in turn, provides for increased air circulation to facilitate healing of the wound.

These and other objects, advantages, purposes, and features of the invention will become more apparent from the study of the following description taken in conjunction with the drawings.

### DETAILED DESCRIPTION OF THE DRAWINGS

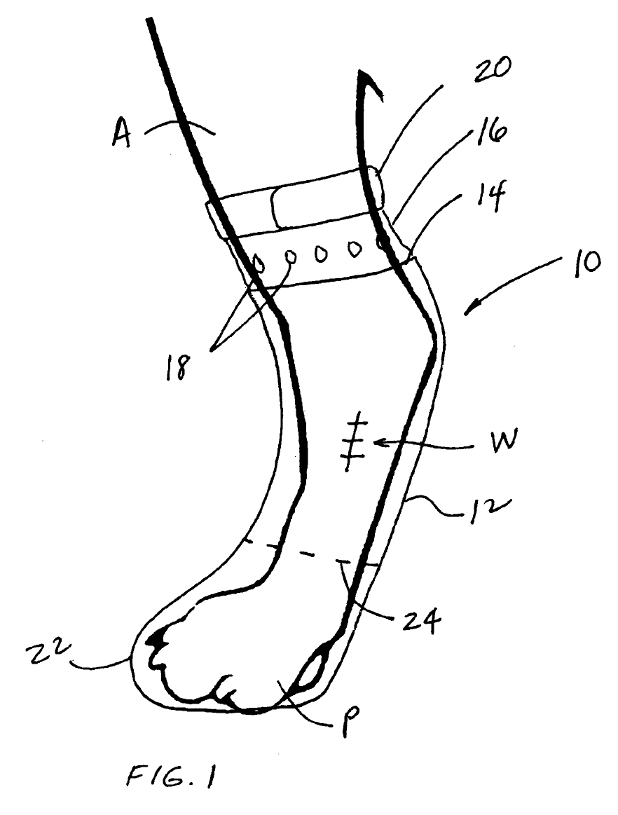

FIG. 1 is front elevation view of a wound cover of the present invention;

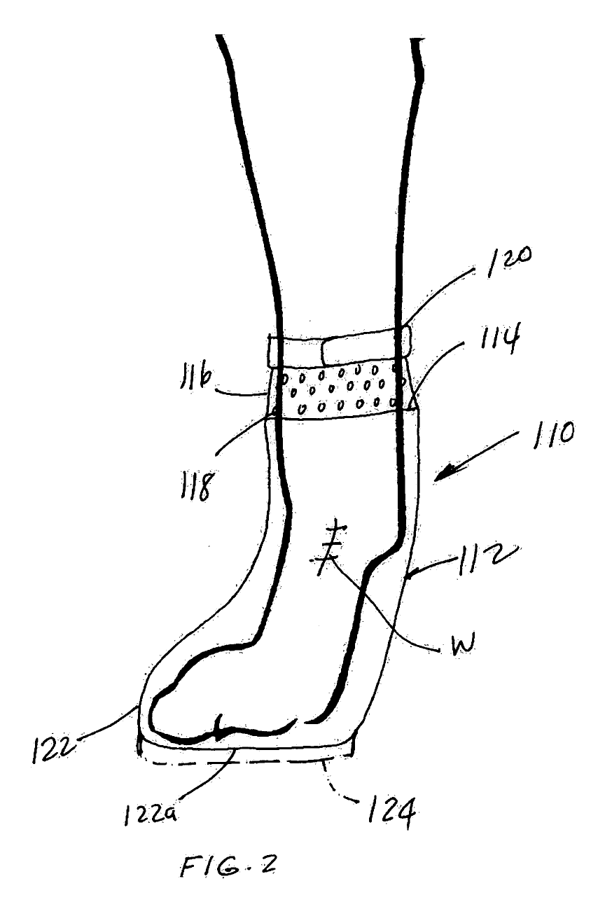

FIG. 2 is an elevation view of another embodiment of the wound cover of the present invention; and

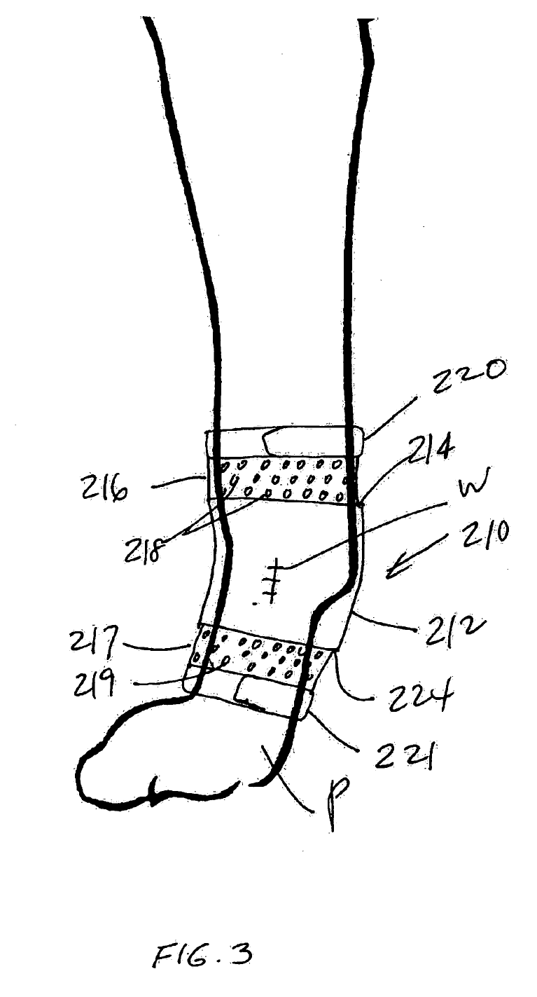

FIG. 3 is a third embodiment of the wound cover of the present invention.

### DETAILED DESCRIPTION OF THE EMBODIMENTS

Referring to FIG. 1, the numeral 10 generally designates a wound cover of the present invention, which is particularly suitable for protecting a wound on an animal's appendage. As will be more fully describe below, wound cover 10 is adapted to allow heat and moisture to escape, and further, facilitate air circulation around the wound W. In addition, wound cover 10 is adapted to allow visualization of the wound W to ensure that the wound is healing properly, and/or to allow any deterioration of the wound, such as bleeding or infection, to be observed without removing of the cover 10.

Wound cover 10 is formed from a plastic tubular body 12, which has a length sufficient to cover the wound W. Tubular body 12 includes an upper open end 14, which allows the appendage of the animal to be inserted into the cover, and a closed lower end 22, which is configured to cover the appendage's paw P. In addition, extending upwardly from upper open end 14 is a flexible sleeve 16 that is adapted to provide venting to allow heat and moisture to escape from tubular body 12, and further facilitates air circulation around the wound W. In the illustrated embodiment, sleeve 16 comprises a foraminous sleeve with a plurality of openings 18. For example, in the illustrated embodiment sleeve 16 includes 8-12 (eight to twelve) openings 18 that are arranged in a single row, each opening having a diameter in a range of about ⅛″ to ⅓″. However, as will be understood from the description that follows, the number and size of openings may be increased or decreased as desired, and further, may be arranged in multiple rows.

Provided at the upper end of sleeve 16 is a strap 20, such as the Velcro strap, or a strap that includes Velcro portions. For example, strap 20 may be secured to sleeve 16 by stitching, gluing or the like. Strap 20 is of a sufficient length to wrap around the appendage A of the animal, and further, has sufficient length to have overlapping ends to secure the cover 10 to the animal. In the illustrated embodiment, as noted, tubular body 12 includes a closed lower end 22, which is configured or shaped to fit over a paw. However, optionally, the lower end 22 of tubular number 12 may be removed by cutting at or near line 24 above the paw of the animal so that the opposed end of tubular body 12 is opened.

In preferred form, tubular body 12 is sized to extend above the carpus or tarsus, and is formed from a material that imparts body 12 with sufficient stiffness so that it can maintain its shape—in other words—so that it is non-collapsing, but which allows some freedom of movement of the animal's appendage below the carpus or tarsus.

As noted above, cover 10 is adapted to allow visualization of the wound W. In one preferred form, tubular body 12 is formed from a substantially clear or transparent plastic. For example, a suitable plastic may include a soft polyvinyl material. Alternately, body 12 may include portions that are formed from a substantially clear or transparent plastic.

In addition, tubular body 12 may incorporate a flavor additive to deter chewing of the cover by the animal. For example, the flavor additive may be sprayed on or otherwise coated onto the tubular body 12, or may be incorporated into the plastic forming the tubular body 12.

As previously noted, tubular body 12 is preferably configured to maintain its shape so that it does not collapse, and further, is thick enough to withstand normal wear and tear and licking by the animal. In addition, sleeve 16 also similarly may comprise a plastic material, which may or may not be clear or transparent, but which is perfectly more flexible than body 12 to help the cover conform to the appendage. For example, when formed from the same material as body 12, sleeve 16 has a wall thickness that is less than the thickness than the wall of tubular body 12 to impart greater flexibility to sleeve 16. Sleeve 16 may be secured to tubular body 12 by adhesive, welding or by other fastening means, including stitching or alike.

Referring to FIG. 2, the numeral 110 generally designates another embodiment of the wound cover of the present invention. Wound cover 110 is a similar construction to wound cover 10 and includes a tubular body 112, which is similarly sized to extend over a wound W and extend above the carpus or tarsus, and a sleeve 116. Tubular body 112 also includes closed end 122 for enclosing the paw of the appendage, though this may also be removed by cutting as described in reference to the first embodiment. Body 112 may be similarly adapted to allow visualization of the wound.

In the illustrated embodiment, sleeve 116 includes a plurality of openings 118 that are arranged in multiple rows, and further, which typically have a smaller diameter than openings 18 of sleeve 16. For example, openings 118 may have diameters in a range of 1/16″ to ¼″. Similarly, sleeve 116 is secured to upper open end 114 of tubular body 112, for example, by welding, adhesive bonding, stitching, or the like. Further, sleeve 116 is similarly secured to a strap 120 to allow cover 110 to be secured animal's appendage.

In addition, cover 110 may include a surface 124, which is formed or otherwise attached to paw section 122 that provides added traction. For example, surface 124 may comprise a material with a higher friction or with an irregular surface that is applied to the bottom of paw portion 122, to increase the friction, and therefore, traction for the animal wearing cover 110. Alternately, the bottom wall 122a of paw portion 122 may be formed with high friction surface, such as an irregular surface or may be two shot molded with a material having a higher friction or the like. In addition, surface 124 may be applied, for example, by spraying on a material, such as foam or rubber-like-material that provides the increased traction.

Referring to FIG. 3, the numeral 210 designates yet another embodiment of the wound cover of the present invention. Wound cover 210 similarly includes a tubular body 210 and includes an upper open end 214 and a lower open end 224. Again, tubular body 212 is sized to have a length sufficient to extend over the wound, and preferably to extend above the carpus or tarsus at open end 214 and below the carpus or tarsus but above the paw P at open end 224. In addition, cover 210 may incorporate one or more sleeves 216 and 217, which are formed from a more flexible material than tubular member 212, and further, which incorporate the plurality of openings 218 and 219, respectively, that provide for venting of moisture and heat, and further, facilitate air circulation over the wound. Each respective sleeve 216, 217 is coupled to a strap 220 and 221 to facilitate the securement of the cover 210 to the animal's appendage. For further details of the sleeves, straps and material forming the tubular number 212, reference is made to the previous embodiments.

Accordingly the present invention provides a wound cover that may be configured in the form of a boot or may be configured simply in the form of a collar that is adapted to facilitate the venting of moisture and heat, and further, allow air to circulate through the cover. In addition, the covers allow for visualization of the wound to provide better care of the wound. Furthermore, each of the covers eliminates the need for most bandages, and is designed for use while the wound is healing, and yet prevents contamination to the wound. In addition as noted above, the covers may incorporate a flavor additive to deter gnawing or biting and further is preferably made from a plastic material that will resist destruction due to gnawing or biting by the animal, while protecting the wound and eliminating a common cause of moist dermatitis.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which I claim an exclusive property right: or privilege are defined as follows:

1. A wound cover comprising:
a plastic tubular body having a length sufficient to cover a wound on an appendage, said tubular body having an upper open end for extending around the appendage;
a strap for extending around the appendage and coupled to said tubular body for securing said tubular body to the appendage over the wound; and
wherein said tubular body is vented to allow heat and moisture to escape and to facilitate air circulation around the wound.

2. The wound cover according to claim 1, wherein said tubular body includes a plurality of openings to form vents.

3. The wound cover according to claim 1, further comprising:
a foraminous sleeve extending from said upper open end and coupling to said tubular body, said foraminous sleeve including a plurality of openings to vent said tubular body, and said strap coupled to said sleeve for securing said sleeve and said tubular body to the appendage over the wound.

4. The wound cover according to claim 3, wherein said sleeve is formed from a flexible plastic.

5. The wound cover according to claim 4, wherein said tubular body has a first wall thickness, said sleeve having a second wall thickness thinner than said first wall thickness.

6. The wound cover according to claim 4, wherein said sleeve is welded to said tubular body.

7. The wound cover according to claim 1, wherein said plastic tubular body comprises a substantially transparent plastic tubular body.

8. The wound cover according to claim 1, wherein said tubular body incorporates a flavor additive, said flavor additive deterring an animal wearing said wound cover from chewing on said cover.

9. A wound cover comprising:
a transparent plastic tubular body having a length sufficient to cover a wound on an appendage, said tubular body being semi-rigid to retain its general shape and having an upper open end for extending around the appendage; and
a strap for extending around the appendage and coupled to said tubular body for securing said tubular body to the appendage over the wound.

10. The wound cover according to claim 9, further comprising:
a foraminous sleeve extending from said upper open end and coupling to said tubular body, said foraminous sleeve including a plurality of openings to allow heat and moisture to escape and to facilitate air circulation around the wound, and said strap coupled to said sleeve for securing said sleeve and said tubular body to the appendage over the wound.

11. The wound cover according to claim 10, wherein said sleeve is formed from a flexible plastic.

12. The wound cover according to claim 11, wherein said tubular body has a first wall thickness, said sleeve having a second wall thickness thinner than said first wall thickness.

13. The wound cover according to claim 12, wherein said sleeve is welded to said tubular body.

14. The wound cover according to claim 9, wherein said cover incorporates a flavor additive, said flavor additive deterring an animal wearing said wound cover from chewing on said cover.

15. The wound cover according to claim 1, wherein said tubular body includes a closed end opposed from said upper open end.

16. A wound cover comprising:
a plastic tubular body having a length sufficient to cover a wound on an appendage, said tubular body having a first thickness and being semi-rigid to retain its general shape and having an upper open end for extending around the appendage;
a plastic sleeve for extending around the appendage, said plastic sleeve having a second thickness less than said first thickness wherein said sleeve is relatively flexible, and said sleeve being vented to allow heat and moisture to escape and to facilitate air circulation around the wound; and
a strap coupled to said tubular body for extending around the appendage and for securing said tubular body to the appendage over the wound.

17. The wound cover according to claim 16, wherein said sleeve is welded to said tubular body.

18. The wound cover according to claim 17, wherein said strap is coupled to said sleeve, said sleeve coupling said strap to said tubular body.

19. The wound cover according to claim 18, wherein said sleeve comprises a foraminous sleeve, said foraminous sleeve including a plurality of openings to vent said tubular body.

20. The wound cover according to claim 16, wherein said plastic tubular body comprises a substantially transparent plastic tubular body.

21. The wound cover according to claim 16, wherein said tubular body incorporates a flavor additive, said flavor additive deterring an animal wearing said wound cover from chewing on said cover.

22. A wound cover comprising:
a plastic tubular body having a length sufficient to cover a wound on an appendage, said tubular body having an upper open end for extending around the appendage;
a strap coupled to said tubular body for extending around the appendage and for securing said tubular body to the appendage over the wound; and
wherein said tubular body incorporates a flavor additive, said flavor additive deterring an animal wearing said wound cover from chewing on said tubular body.

23. The wound cover according to claim 22, wherein said tubular body is vented to allow heat and moisture to escape and to facilitate air circulation around the wound.

24. The wound cover according to claim 22, further comprising:
a flexible sleeve extending from said upper open end and coupling to said tubular body, and said strap coupled to said sleeve for securing said sleeve and said tubular body to the appendage over the wound.

25. The wound cover according to claim 24, wherein said sleeve is formed from a plastic material.

26. The wound cover according to claim 25, wherein said sleeve is welded to said tubular body.

27. The wound cover according to claim 22, wherein said plastic tubular body comprises a substantially transparent plastic tubular body.

28. The wound cover according to claim 22, wherein said tubular body has a closed lower end opposed from said upper open end, said closed lower end adapted to substantially conform to the paw of the appendage.

29. The wound cover according to claim 28, wherein said closed lower end includes a traction surface.
